(19) United States
(12) Patent Application Publication
(10) Pub. No.: US 2024/0392145 A1
(43) Pub. Date: Nov. 28, 2024

(54) SOLVENT COMPOSITIONS

(71) Applicant: Airbus Operations SAS, TOULOUSE (FR)

(72) Inventors: Alix COURTADON, TOULOUSE (FR); Jeanne JULIAN, BLAGNAC (FR); Claire DUBOUE, BLAGNAC (FR)

(21) Appl. No.: 18/673,934

(22) Filed: May 24, 2024

(30) Foreign Application Priority Data
May 26, 2023 (FR) 2305243

(51) Int. Cl. C09D 9/00

(52) U.S. Cl. CPC C09D 9/005

(57) ABSTRACT

A solvent composition for solvent-based paints or other similar coatings which comprises a combination of dimethyl glutarate and of at least one other compound chosen from a group which includes isobutyl acetate, ethyl lactate, dimethyl 2-methylglutarate, 2-methyltetrahydrofuran, ethyl acetate, cyclopentyl methyl ether, diethoxymethane, dimethyl carbonate, dimethyl succinate, benzyl alcohol, dimethyl adipate or glycerol triacetate. Also a method of cleaning with such a solvent composition.

### CROSS-REFERENCES TO RELATED APPLICATIONS

This application claims the benefit of French Patent Application Number 2305243 filed on May 26, 2023, the entire disclosure of which is incorporated herein by way of reference.

### FIELD OF THE INVENTION

The present invention relates to solvent compositions, in particular for cleaning solvent-based paints, more particularly for cleaning equipment used in the preparation and/or the application of industrial paints.

### BACKGROUND OF THE INVENTION

At the industrial level, paints are applied as coatings using items of equipment such as pumps, pipes, guns, brushes or rollers. These items of equipment must be cleaned once the application of the paint has been carried out. Likewise, the items of equipment necessary for the preparation of the paint must be cleaned once the paint has been prepared. As these paints are solvent-based, cleaning is carried out using solvents.

Many solvents, for example organic or water-based, are available today. However, depending on their compositions, they exhibit variable characteristics of effectiveness, of dangerousness during use or of storage and of pollution.

This is because the paints used in industry, for example to coat mechanical parts, have variable compositions. They can in particular be based on polyepoxide, on polyurethane or on other types of polymers. Some solvents are not capable of dissolving any type of paint and can leave residues or also create precipitates.

Moreover, the flash point of a solvent is an essential characteristic in terms of dangerousness. This is because the flash point determines the flammability of the solvent. This is the lowest temperature at which a product releases enough vapor to form a flammable mixture with the air. A solvent exhibiting an excessively low flash point with respect to its conditions of use or of storage thus presents serious risks.

Finally, it is known that solvents are one of the main sources responsible for the emission of volatile organic compounds, or VOCs. In point of fact, more and more companies are now committed to reducing the environmental impact of their industrial processes and are implementing environmental management systems, in particular in accordance with the standards in force, such as Standard ISO 14001.

### SUMMARY OF THE INVENTION

The aim of the present invention is to provide solvent compositions, in particular for the cleaning of items of equipment for the preparation and/or application of solvent-based paints or other surface coatings, which simultaneously exhibit a certain effectiveness for these paints, a reduction in the risks of flammability related to the flash point during use or storage and a controlled environmental impact, in particular in terms of emissions of volatile organic compounds.

To this end, the invention relates to a solvent composition for paints or other coatings, comprising dimethyl glutarate and at least one other compound chosen from isobutyl acetate, ethyl lactate, dimethyl 2-methylglutarate, 2-methyltetrahydrofuran, ethyl acetate, cyclopentyl methyl ether, diethoxymethane, dimethyl carbonate, dimethyl succinate, benzyl alcohol, dimethyl adipate or glycerol triacetate.

The composition according to the invention is shown to be entirely effective in dissolving the solvent-based paints generally used in industry, such as primer paints, base coats, top coats, varnishes, in particular paints or other coatings based on polyurethane, on polyepoxides or on other types of polymers, and thus efficiently cleaning the items of equipment for the preparation and/or application of paints.

The composition according to the invention can be used with a limited risk of flammability. This is because, whatever the combinations of components proposed, these will exhibit a minimum flash point suitable for the conditions of use and of storage.

Thus, advantageously, the composition according to the invention exhibits a flash point of greater than or equal to 39° C.

The flash point can be determined according to known closed cup methods, in particular by following Standard EN ISO 3679 (or any other standard in force specifying flash point test procedures for paints).

Also advantageously, the composition exhibits a content of volatile organic compounds of less than 50% by weight.

The content of volatile organic compounds can be measured according to known methods, by following Standard EN ISO 11890-1 (or any other standard in force specifying procedures for measuring VOCs for paints), in particular by following the measurement method 1 set out in Standard EN ISO 11890-1. According to this method, the percentage by weight of volatile organic compounds is calculated according to the following formula:

$$VOC = 1 \; 00 - NV - Ww \qquad [ EQ . 1 ]$$

in which:
VOC is the content of volatile organic compounds, in percentage by weight;
NV is the content of non-volatile compounds, in percentage by weight; and,
Ww is the water content, in percentage by weight.

Preferentially, the composition comprises at least 40% by volume of dimethyl glutarate, with respect to the total volume of the composition.

According to a preferred embodiment of the invention, the composition comprises dimethyl glutarate in combination with isobutyl acetate and/or ethyl lactate.

Advantageously, the composition consists solely of dimethyl glutarate in combination with isobutyl acetate and/or ethyl lactate.

Advantageously, the composition comprises between 50% and 80% of dimethyl glutarate and between 20% and 50% of isobutyl acetate and/or of ethyl lactate, by volume, with respect to the total volume of the composition.

According to one embodiment, the composition comprises between 50% and 55% of dimethyl glutarate, between 30% and 35% of isobutyl acetate and between 20% and 25% of ethyl lactate, by volume, with respect to the total volume of the composition.

According to another embodiment, the composition comprises between 50% and 55% of dimethyl glutarate, between 30% and 35% of ethyl lactate and between 20% and 25% of isobutyl acetate, by volume, with respect to the total volume of the composition.

According to another embodiment, the composition comprises between 50% and 55% of dimethyl glutarate and between 45% and 50% of ethyl lactate or of isobutyl acetate, by volume, with respect to the total volume of the composition.

According to another embodiment, the composition comprises between 70% and 80% of dimethyl glutarate and between 20% and 30% of isobutyl acetate, by volume, with respect to the total volume of the composition.

Preferentially, the composition according to the invention comprises at most 20% of a compound chosen from dimethyl 2-methylglutarate, 2-methyltetrahydrofuran, ethyl acetate, cyclopentyl methyl ether, diethoxymethane, dimethyl carbonate, dimethyl succinate, benzyl alcohol, dimethyl adipate or glycerol triacetate or of one of their mixtures, by volume, with respect to the total volume of the composition.

The invention also relates to a process for cleaning items of equipment for the preparation and/or application of solvent-based paints or of other coatings, characterized in that it comprises at least one stage of cleaning said items of equipment using a solvent composition as defined above.

### BRIEF DESCRIPTION OF THE DRAWINGS

The abovementioned characteristics of the invention, and also others, will become more clearly apparent on reading the examples which follow and in connection with the following appended drawings:

FIG. 1 is an illustration of a device used to determine the effectiveness of solvent compositions according to the invention;

FIG. 2 is TABLE 1 showing various mixtures of solvent compositions produced according to the present invention; and,

FIG. 3 is TABLE 2 showing the contents of volatile organic compounds (VOCs) of various solvent compositions according to the invention.

### DETAILED DESCRIPTION OF THE PREFERRED EMBODIMENTS

### Example 1: Effectiveness Tests and Measurement of the Flash Point

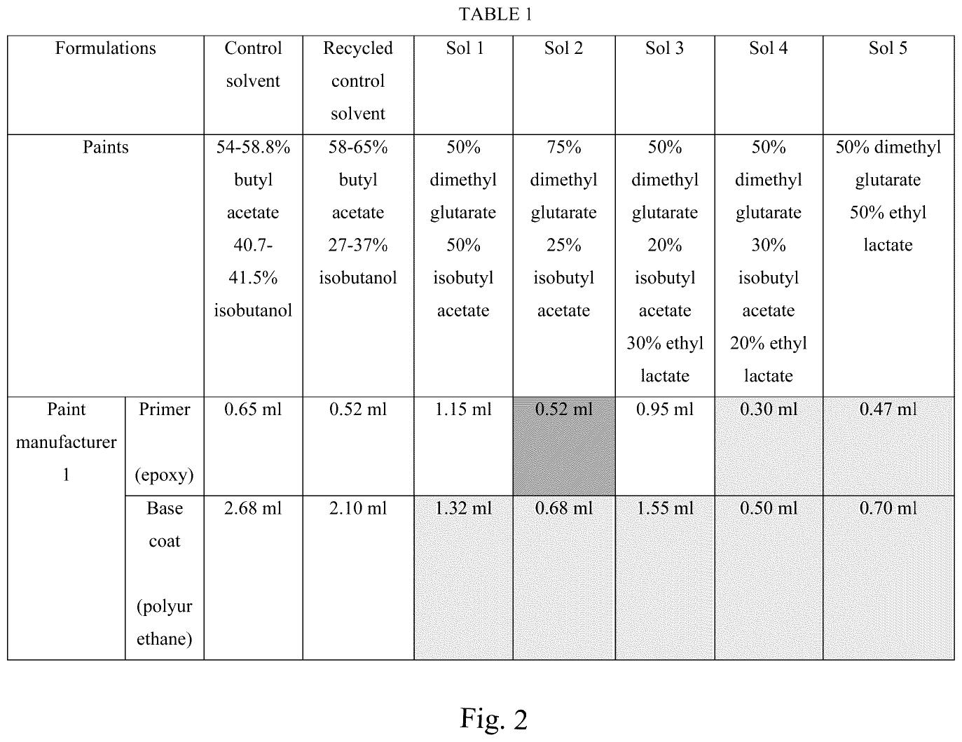

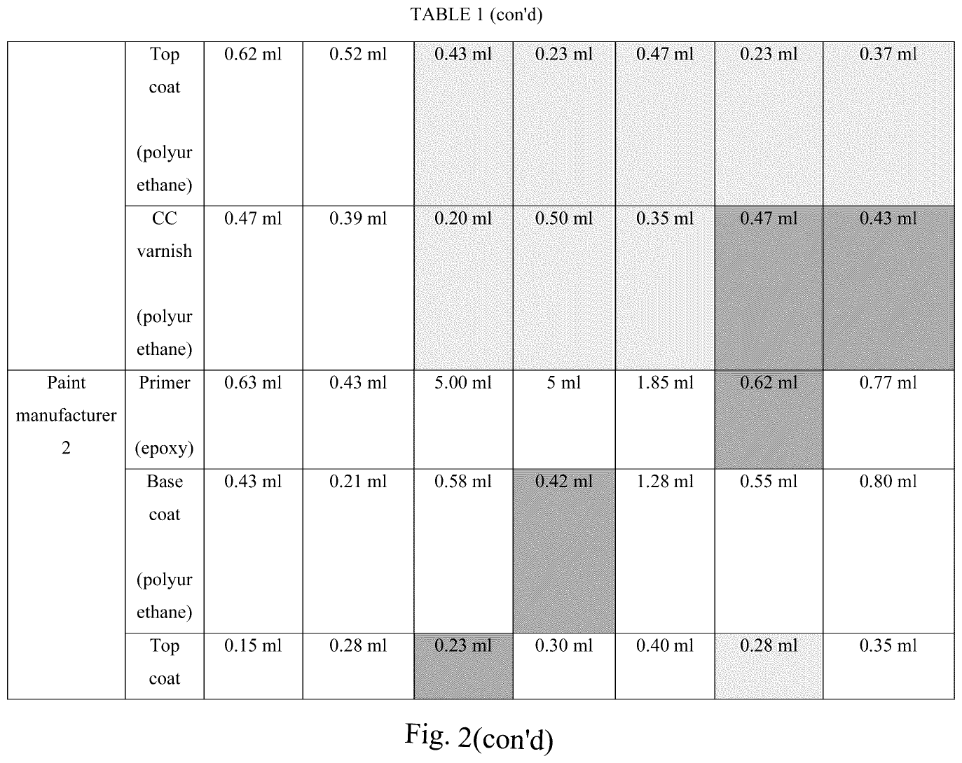

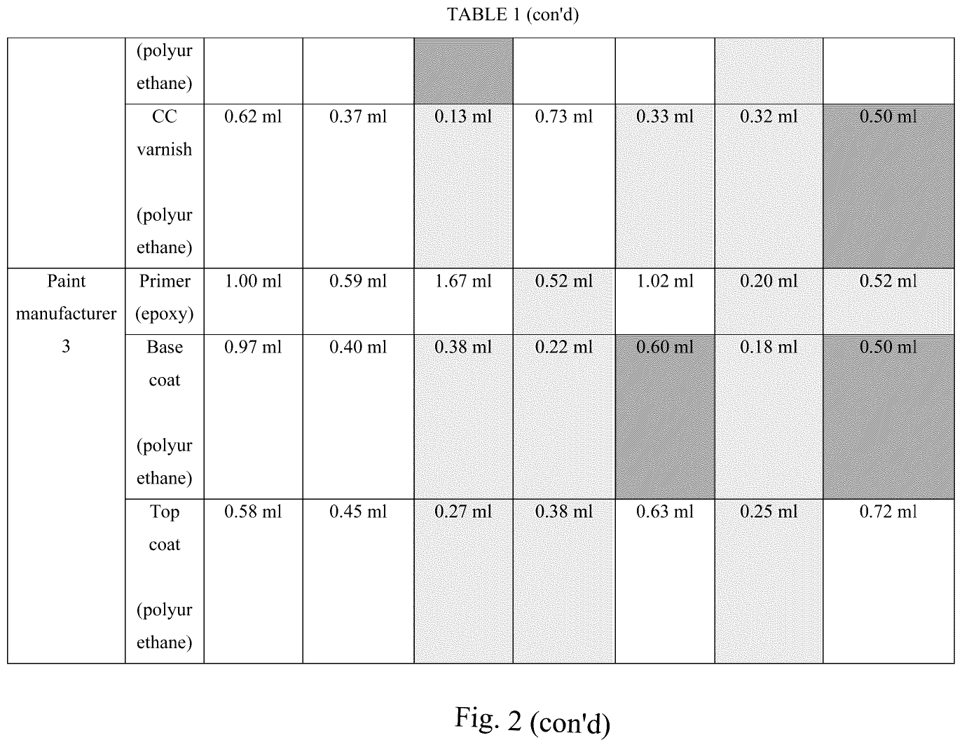

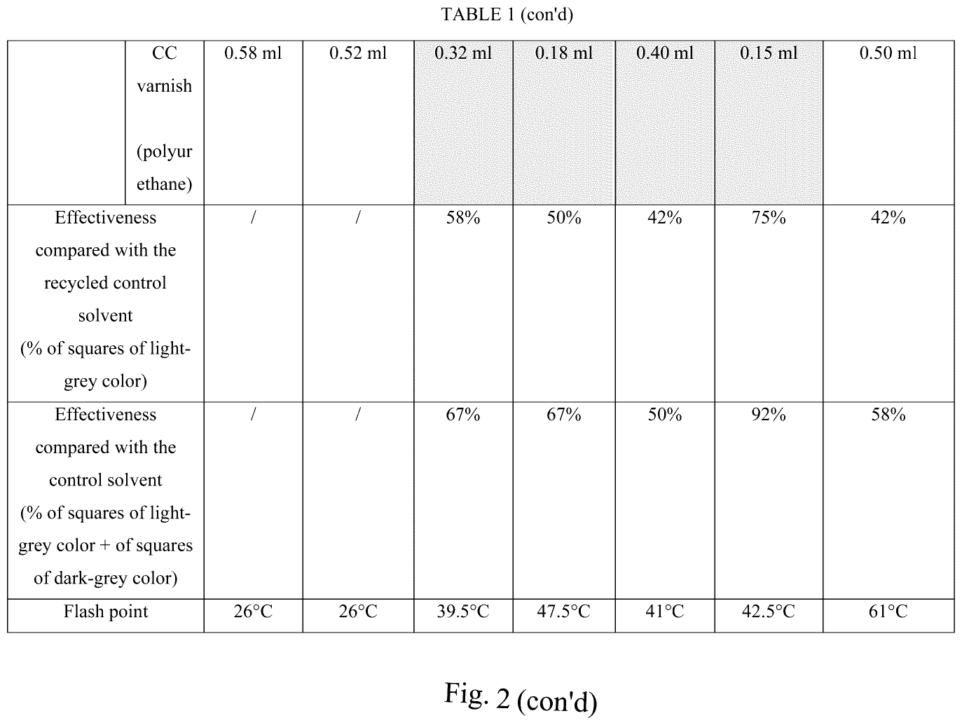

Five solvent compositions (Sol 1; Sol 2; Sol 3; Sol 4; Sol 5) according to the invention were prepared according to the mixtures shown in Table 1 (FIG. 2).

Their effectiveness with regard to the dissolution of different types of paints was compared with that of a commercial control solvent.

The trade names of the paints, as well as their main component, are also shown in Table 1 (FIG. 2).

The results of the effectiveness tests and also the flash point of each solvent composition are shown in Table 1 (FIG. 2).

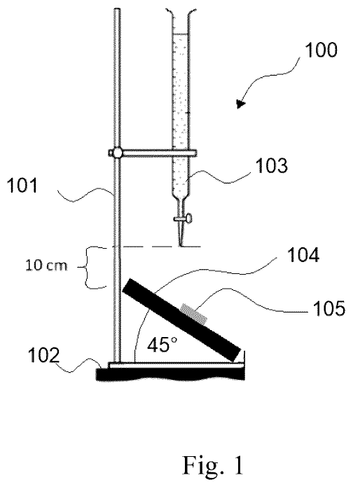

The effectiveness with regard to the dissolution of different types of paint was determined using the device 100 illustrated in FIG. 1. The device 100 is composed of a burette support 101 exhibiting a base 102, of a graduated burette 103 and of an aluminum test specimen 104. The burette 103 is filled with 10 ml of solvent. The distance between the tip of the graduated burette 103 and the aluminum test specimen 104 is 10 cm. The aluminum test specimen 104 and the base 102 form an angle of 45° between them. A strip of solvent-based paint 105 with a width of approximately 1 cm and with a thickness of approximately 30 μm is applied over the entire width of the test specimen 104. The amount of solvent necessary to dissolve the layer of paint 105 is subsequently measured.

It is noticed first of all that the five solvents according to the invention exhibit a flash point of greater than 39° C., whereas the control solvent exhibits a flash point of 26° C. At such a value, the control solvent cannot be used without danger, whereas the five solvents according to the invention can be used and stored more safely.

Furthermore, the five solvents according to the invention have been shown to be effective in dissolving all the layers of paint. Their effectiveness, compared to that of the controls, is much higher. This is because, compared with the control solvent, the solutions 1, 2, 3, 4 and 5 exhibit an effectiveness of 58%, 50%, 42%, 75% and 42% respectively. Compared with the recycled control solvent, the solutions 1, 2, 3, 4 and 5 exhibit an effectiveness of 67%, 67%, 50%, 92% and 58% respectively.

It is noted in particular that the solvent 4 stands out in terms of effectiveness.

### Example 2: Contents of Volatile Organic Compounds

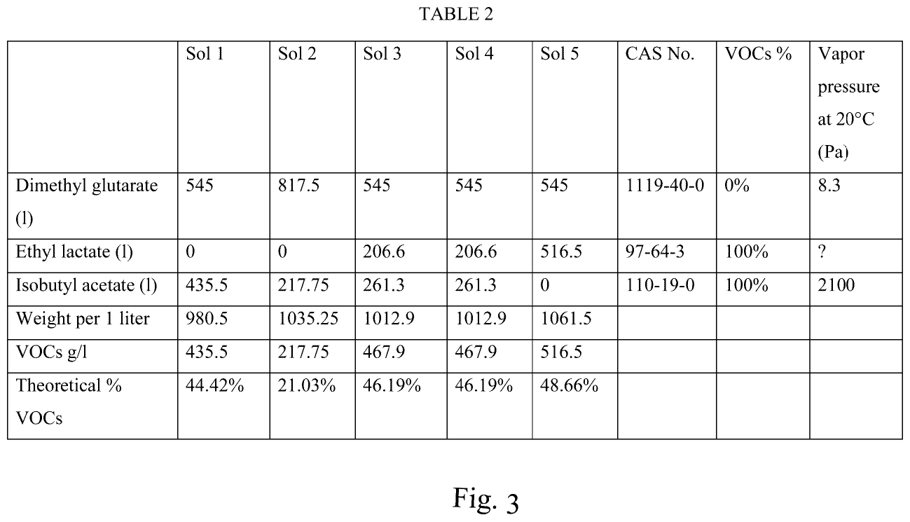

The contents of volatile organic compounds (VOCs) of the 5 solvent compositions according to the invention are presented in Table 2 (FIG. 3).

The five solvents according to the invention exhibit an acceptable content of VOCs of less than 50%, whereas the control solvent exhibits a content of VOCs of 100%.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A solvent composition for paints or other coatings, the solvent composition comprising:
between 50% and 80% of dimethyl glutarate;
between 20% and 50% of isobutyl acetate or of a mixture of isobutyl acetate and of ethyl lactate, by volume, with respect to a total volume of the solvent composition.

2. The solvent composition according to claim 1, wherein the solvent composition exhibits a flash point of greater than or equal to 39° C.

3. The solvent composition according to claim 1, wherein the solvent composition exhibits a content of volatile organic compounds of less than 50% by weight.

4. The solvent composition according to claim 1, wherein the solvent composition comprises:
between 50% and 55% of dimethyl glutarate,
between 30% and 35% of isobutyl acetate, and
between 20% and 25% of ethyl lactate, by volume, with respect to the total volume of the solvent composition.

5. The solvent composition according to claim 1, wherein the solvent composition comprises:
between 50% and 55% of dimethyl glutarate,
between 30% and 35% of ethyl lactate, and
between 20% and 25% of isobutyl acetate, by volume, with respect to the total volume of the solvent composition.

6. The solvent composition according to claim 1, wherein the solvent composition comprises:
between 70% and 80% of dimethyl glutarate, and
between 20% and 30% of isobutyl acetate, by volume, with respect to the total volume of the solvent composition.

7. The solvent composition according to claim 1, wherein the solvent composition comprises, at most, 20% of a compound chosen from a group consisting of: dimethyl 2-methylglutarate, 2-methyltetrahydrofuran, ethyl acetate, cyclopentyl methyl ether, diethoxymethane, dimethyl carbonate, dimethyl succinate, benzyl alcohol, dimethyl adipate, glycerol triacetate, and mixtures thereof, by volume, with respect to the total volume of the solvent composition.

8. A process for cleaning items of equipment for a preparation, or an application, or both of solvent-based paints or of other coatings, the process comprising:
at least one stage of cleaning an item of equipment with the solvent composition according to claim 1.
